(19) United States
(12) Patent Application Publication
(10) Pub. No.: US 2026/0044170 A1
(43) Pub. Date: Feb. 12, 2026

(54) METHOD FOR THE DESIGN OF LOW NOISE PRECISION BANDGAP VOLTAGE REFERENCES

(71) Applicant: Analog Devices, Inc., Wilmington, MA (US)

(72) Inventor: Michael Brian Anderson, Colorado Springs, CO (US)

(21) Appl. No.: 18/795,640

(22) Filed: Aug. 6, 2024

(51) Int. Cl. G05F 3/30

(52) U.S. Cl. CPC G05F 3/30

(57) ABSTRACT

A voltage reference circuit includes a bandgap voltage reference circuit, and an amplifier circuit including a first input coupled to an output of the bandgap voltage reference circuit and a second input directly coupled to an output of the amplifier.

### BACKGROUND

Voltage reference circuits are used in many applications in integrated circuits to provide a known voltage. Bandgap voltage references are a type of voltage reference circuit that provides a stable output voltage that is independent of external factors such as temperature, power supply variations, and load conditions. Bandgap voltage references are widely used in electronic systems where precise and stable voltage references are crucial, such as in analog-to-digital converters, digital-to-analog converters, and power supply circuits. The output of a bandgap voltage reference can be amplified to produce a different voltage level. However, amplifying a bandgap voltage reference can introduce unwanted circuit noise.

### Overview

This document pertains generally, but not by way of limitation, to techniques to reduce noise in voltage reference circuits. In one aspect, a voltage reference circuit voltage reference circuit includes a bandgap voltage reference circuit, and an amplifier circuit including a first input coupled to an output of the bandgap voltage reference circuit and a second input directly coupled to an output of the amplifier.

In another aspect, a method of generating a reference voltage in an integrated circuit (IC) includes connecting an adjustable complementary-to-absolute-temperature (CTAT) circuit and an adjustable proportional-to-absolute-temperature (PTAT) circuit in series to produce an adjustable reference output voltage at a first circuit node, connecting the first circuit node to a first input of an amplifier circuit, and connecting a second input of the amplifier circuit directly to an output of the amplifier circuit.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a circuit diagram of an example of a voltage reference circuit.

FIG. 2 is a circuit diagram of an example of a voltage reference circuit with noise sources shown.

FIG. 3 is a circuit diagram of another example of a voltage reference circuit.

FIG. 4 is a circuit diagram of still another example of a voltage reference circuit.

FIG. 5 is a graph of the square of the output voltage noise of the voltage reference circuit in FIG. 4 as a function of frequency.

FIG. 6 is a circuit diagram of another example of a voltage reference circuit.

FIG. 7 is a circuit diagram of an example of an adjustable voltage reference circuit.

FIG. 8 is a circuit diagram of another example of an adjustable voltage reference circuit.

FIG. 9 is a circuit diagram of an adjustable voltage reference circuit and buffer circuit.

FIG. 10 is a circuit diagram of another example of a voltage reference circuit.

FIG. 11 is a circuit diagram of another example of an adjustable voltage reference circuit.

FIG. 12 is a flow diagram of an example of generating a reference voltage in an integrated circuit.

### DETAILED DESCRIPTION

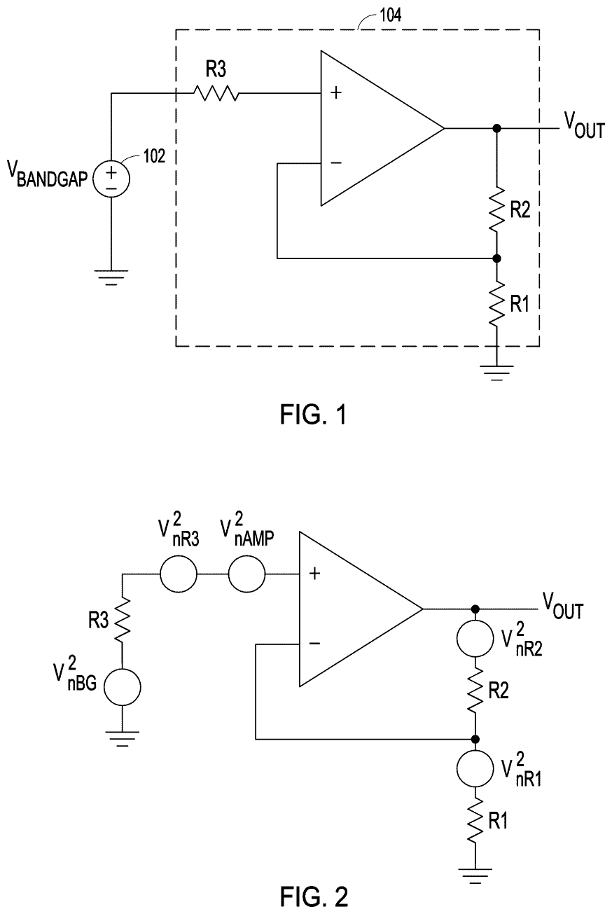

FIG. 1 is a circuit diagram of an example of a voltage reference circuit. A known voltage is produced using a voltage source and then amplified to produce a desired reference output voltage. In the example of FIG. 1, the voltage source is a bandgap reference circuit 102 that produces a bandgap voltage V_{BANDGAP}. The bandgap voltage produced is amplified using a buffer circuit 104 that multiplies the bandgap voltage by circuit gain to produce the desired reference output voltage V_{OUT}. However, the buffer circuit 104 of FIG. 1 adds noise to the circuit and the noise is amplified by the gain of the buffer circuit 104.

FIG. 2 is a circuit diagram of the example circuit in FIG. 1 with noise sources shown as voltage sources. Circuit noise is added by the amplifier and resistors. The square of the total circuit noise v_{nTotal} in the circuit example of FIG. 2 can be expressed as

$${v}_{nTotal}^{2} = {v}_{nR 1}^{2} \frac{{R}_{2}}{{R}_{1}} + ( {v}_{n B G}^{2} + {v}_{n A M P}^{2} + {v}_{nR 3}^{2} ) ( 1 + \frac{{R}_{2}}{{R}_{1}} ) + {v}_{nR 2}^{2} ,$$

where v_{nR1} is the circuit noise contributed by R1, V_{nR2} is the circuit noise contributed by R2, v_{nR3} is the circuit noise contributed by R3, VRAMP is the circuit noise contributed by the amplifier, and v_{nBG} is the circuit noise contributed by the bandgap circuit 102. It can be seen from the equation that the noise contributed by the circuit components is amplified by the gain of the buffer circuit 104. The amplification of the noise may detract from a low noise circuit design.

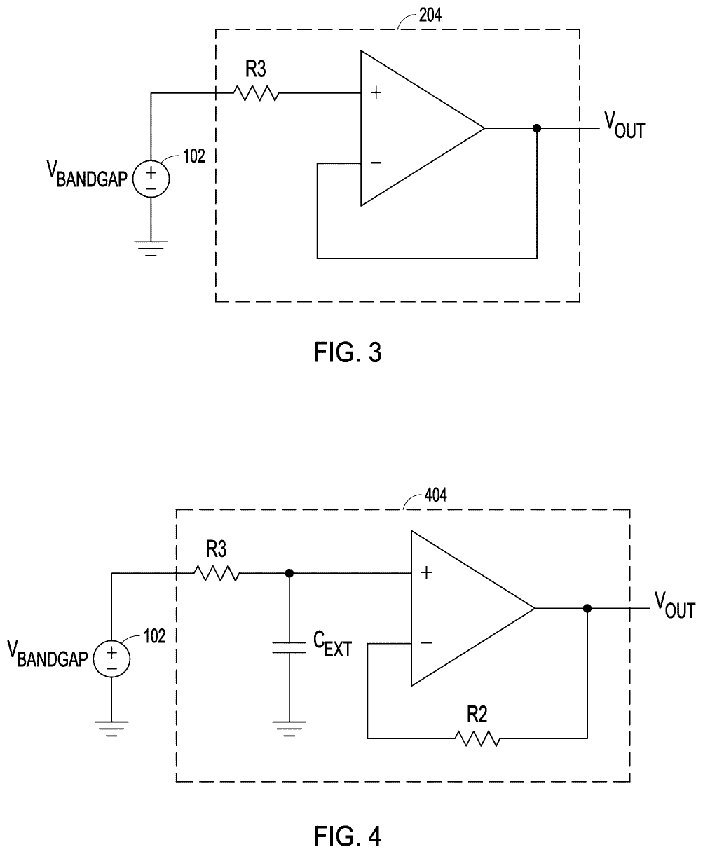

FIG. 3 is a circuit diagram of another example of a voltage reference circuit. The voltage reference circuit includes a bandgap reference circuit 102 and a buffer circuit 304. The buffer circuit 304 eliminates the R1 and R2 resistors and thus eliminates the noise contributed by the R1 and R2 resistors. The buffer circuit 304 provides unity gain and thus the circuit noise contributed by resistor R3, the amplifier, and the bandgap references is not amplified. This reduces the expression for the circuit noise to

$${v}_{nTotal}^{2} = {v}_{n B G}^{2} + {v}_{n A M P}^{2} + {v}_{nR 3}^{2} .$$

Thus, the circuit noise in the voltage reference circuit of FIG. 3 has fewer noise sources and the noise sources are not amplified. This results in much lower circuit noise than the voltage reference circuit of FIG. 1. Additionally, current is not consumed through the feedback of the buffer circuit 304 as it is in the buffer circuit 104 of FIG. 1, and the voltage reference circuit of FIG. 3 uses less current than the voltage reference circuit 104 of FIG. 1.

FIG. 4 is a circuit diagram of another example of a voltage reference circuit. The voltage reference circuit includes a bandgap reference circuit 102 and a buffer circuit 404. The circuit noise contributed by the bandgap circuit 102 is roughly ten times the circuit noise contributed by the buffer circuit 404. The circuit noise from the bandgap reference can be bandlimited by filtering. In the example of FIG. 4 the output of the bandgap reference circuit 102 is bandlimited using a resistor-capacitor (RC) filter that includes resistor R3 and capacitor C_{EXT}. The capacitor can be external to the integrated circuit that includes the bandgap reference circuit 102 and the amplifier, and the integrated circuit can include a pin for connecting the capacitor to the buffer circuit 404.

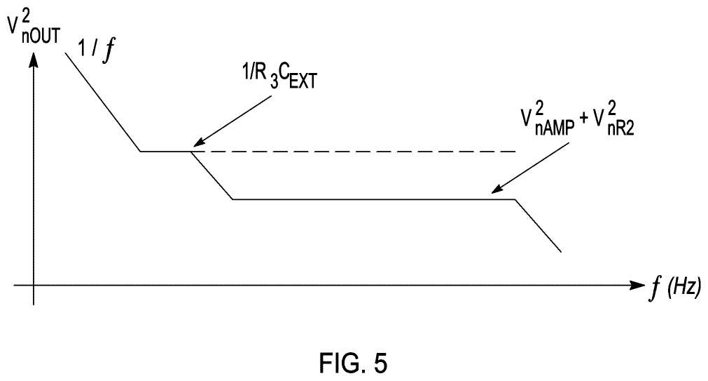

FIG. 5 is a graph of the square of the output voltage noise

$$( {v}_{n O U T}^{2} )$$

as a function of frequency. The corner frequency introduced by the RC filter bandlimits the output noise to

$${v}_{nTotal}^{2} = {v}_{n A M P}^{2} + {v}_{nR 3}^{2}$$

at the higher frequencies. Thus, the circuit noise in the voltage reference circuit of FIG. 4 is much lower than in the voltage reference circuit of FIG. 1. However, the flexibility in FIG. 1 of using the gain of the buffer circuit 104 to determine the reference output voltage is not available in the circuit examples of FIGS. 3 and 4. The reference output voltage produced by the voltage reference can be changed by using an adjustable voltage reference circuit and avoiding amplification that introduces circuit noise.

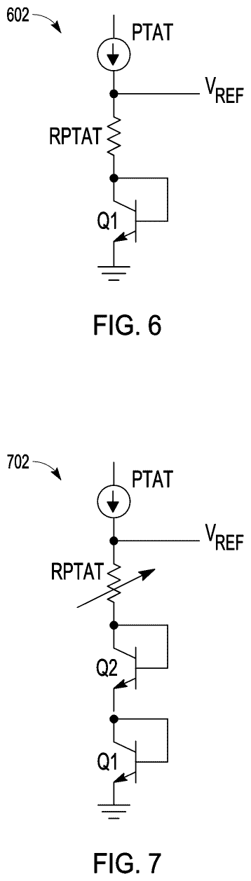

FIG. 6 is a circuit diagram of an example of a voltage reference circuit 602. The voltage reference circuit 602 sums contributions from Proportional-to-Absolute-Temperature (PTAT) circuit and a Complementary-to-Absolute-Temperature (CTAT) circuit (PTAT+CTAT) to produce a reference voltage V_{REF} that is stable with temperature. The PTAT circuit includes a PTAT current source and resistor RPTAT, and the CTAT circuit includes the diode connected transistor Q1. The PTAT current in resistor RPTAT produces a voltage that is summed with the voltage of the diode connected transistor Q1. In the example of FIG. 6, the voltage V_{REF} may be 1.22 Volts (1.22V).

FIG. 7 is a circuit diagram another example of a voltage reference circuit 702. The voltage reference circuit 702 sums contributions from a PTAT circuit and a CTAT circuit. In the example of FIG. 7, the CTAT circuit includes a second diode connected transistor Q2 connected in series to first diode connected transistor Q1. The PTAT circuit includes an adjustable resistor RPTAT. The voltage reference circuit 702 may produce a voltage V_{REF} of 2.44V. The PTAT circuit is adjustable and the voltage V_{REF} may be adjusted by adjusting the value of RPTAT.

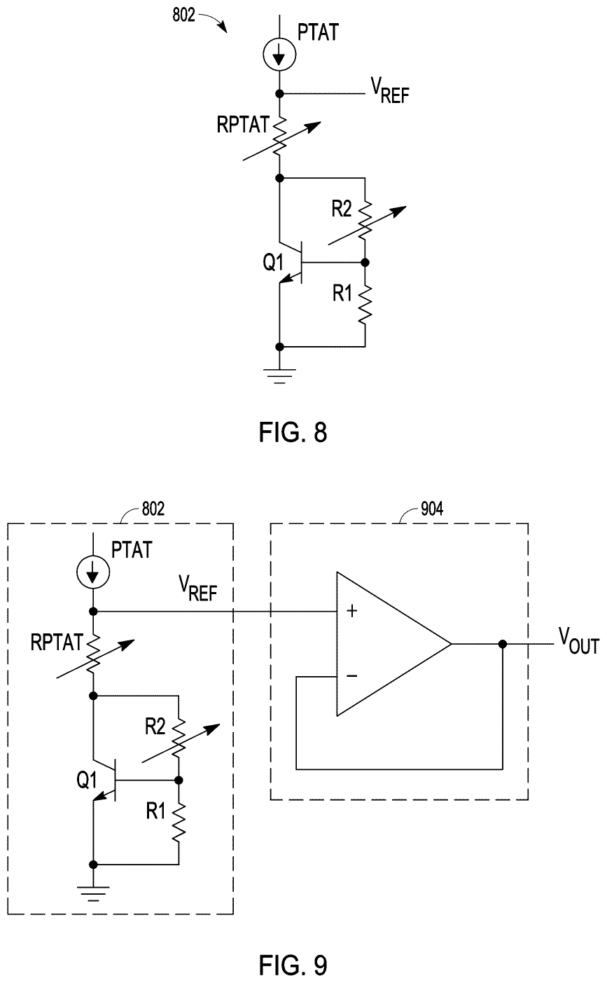

FIG. 8 is a circuit diagram another example of a voltage reference circuit 802. The PTAT circuit is adjustable as in FIG. 7. In the example of FIG. 8, the diode connected transistors in the example of FIG. 7 are replaced with a base-emitter voltage (VBE) multiplier circuit that includes transistor Q1, resistor R1 and adjustable resistor R2. The VBE multiplier circuit produces a voltage v_{MULT} that is approximately

$${V}_{MULT} = ( 1 + \frac{{R}_{2}}{{R}_{1}} ) {V}_{D I O D E} .$$

In the example of FIG. 8, the voltage V_{REF} is the sum of the voltage produced by the PTAT current applied to the resistor RPTAT plus the voltage of the VBE multiplier. The VBE multiplier circuit increases the voltage contribution of the CTAT circuit as compared to the diode approach of FIGS. 6 and 7. The CTAT circuit is adjustable, and the voltage produced by the VBE multiplier circuit can be adjusted by adjusting the resistance of R2. In an example, the voltage reference circuit 802 may produce a voltage V_{REF} of 2.5V.

FIG. 9 is an example of a voltage reference circuit that includes the adjustable voltage reference circuit 802 of FIG. 8 and a unity gain buffer circuit 904. The output V_{REF} of any of the voltage reference circuits of FIGS. 6, 7, and 8 can be applied to the unity gain buffer circuit 904 to produce the desired reference output voltage V_{OUT}. The circuit minimizes output noise contributed by output buffer gain. In the example of FIG. 9, the reference output voltage V_{OUT} can be adjusted to the desired value by adjusting one or both of the PTAT circuit and the CTAT circuit.

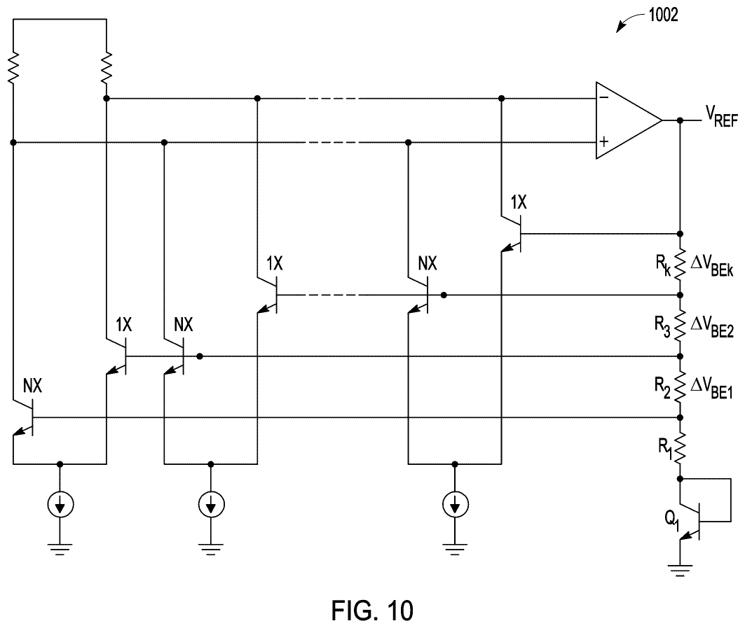

FIG. 10 is a circuit diagram another example of a voltage reference circuit 1002. The voltage reference circuit 1002 includes a PTAT circuit and a CTAT circuit. The CTAT circuit includes the diode connected transistor Q1 as in the example of FIG. 6. The PTAT circuit includes multiple base-emitter voltage difference (ΔVBE) circuits. The ΔVBE circuits include a unit sized (1×) transistor and an N-unit sized transistor (Nx), where N is a positive integer greater than 1, and the difference in transistor size produces a difference in VBE (ΔVBE). The outputs of the ΔVBE circuits are connected in series in a stack. The outputs of the ΔVBE circuits and the CTAT circuit are connected in series to produce an aggregate reference voltage at the V_{REF} circuit node which may be connected to a unity gain buffer circuit (e.g., the unity gain buffer circuit 904 of FIG. 9). The ΔVBE circuits replace the RPTAT resistor in FIG. 6, which can be a source of circuit noise. In the example of FIG. 10, there are k ΔVBE circuits, where k is an integer greater than one. The number ΔVBE circuits used in the voltage reference circuit 1002 can be determined by the target V_{REF} voltage, where

$${V}_{R E F} = {v}_{T} ( 1 + \frac{{R}_{1}}{{R}_{2}} ) ln ( {N}^{k} ) + {v}_{B E} .$$

The stacked ΔVBE circuits may reduce noise over the RPTAT resistor approach. A filter circuit (e.g., RC filter circuit of FIG. 4) can be added to bandlimit the noise.

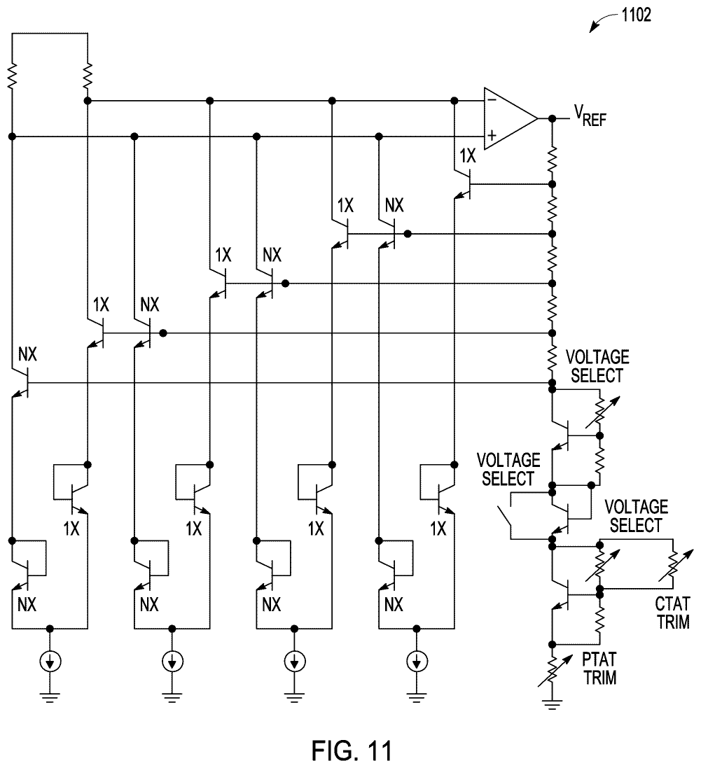

FIG. 11 is a circuit diagram another example of a voltage reference circuit 1102. The diode connected transistor Q1 in FIG. 10 can be replaced with a VBE multiplier circuit as in the example of FIG. 8. As noted previously herein, the gain of the VBE multiplier circuit is (1+R2/R1). The voltage reference circuit 1102 includes multiple VBE multiplier circuit to break up the R2 gain resistor of FIG. 8, which can reduce circuit noise. The voltage reference circuit 1102 includes four ΔVBE circuits and two VBE multiplier circuits that are adjustable. The voltage reference circuit 1102 also includes trim resistors to trim the PTA current and the CTAT current. The voltage reference circuit 1102 produces a reference voltage at the V_{REF} circuit node, and the V_{REF} circuit node is connected to a unity gain buffer circuit (e.g., the unity gain buffer circuit 904 of FIG. 9). A filter circuit (e.g., the RC filter circuit of FIG. 4) can be added to bandlimit the noise.

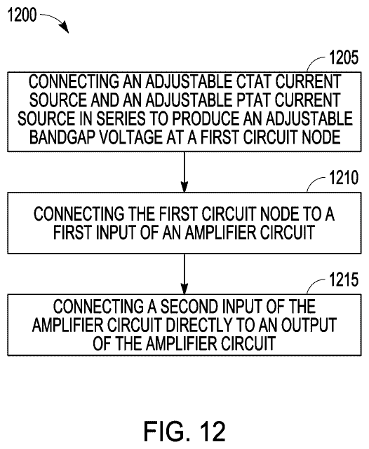

FIG. 12 is a flow diagram of an example of generating a reference voltage in an integrated circuit. At block 1205, an adjustable CTAT circuit and an adjustable PTAT circuit are connected in series to produce an adjustable reference output voltage at a circuit node. The adjustable CTAT circuit can include any of the adjustable CTAT circuits described herein. In some examples, the CTAT circuit includes one or more adjustable VBE multiplier circuits. The adjustable PTAT circuit can include any of the adjustable PTA circuits described herein. In some examples, the adjustable PTAT circuit includes a PTAT current source and an adjustable resistance. In certain examples, the PTAT current source is trimmable. In some examples, the adjustable PTAT circuit includes multiple ΔVBE circuits.

At block 1210, the circuit node is connected to a first input of an amplifier circuit. The amplifier circuit may include a differential input and a single ended output. At block 1215, the second input of the amplifier circuit is connected directly to the output of the amplifier circuit. The amplifier circuit may be included in a unity gain buffer circuit as in the examples of FIG. 3 and FIG. 9. In some examples, the reference output voltage is filtered, such as by connecting the circuit node to an RC filter circuit as in the example of FIG. 4.

The devices, systems and methods described herein provide techniques that provide a voltage reference with low circuit noise.

### Additional Description and Aspects

A first Aspect (Aspect 1) includes subject matter (such as a voltage reference circuit) comprising a bandgap voltage reference circuit, and an amplifier circuit. The amplifier circuit includes a first input coupled to an output of the bandgap voltage reference circuit and a second input directly coupled to an output of the amplifier.

In Aspect 2, the subject matter of Aspect 1 optionally includes the bandgap voltage reference circuit being an adjustable bandgap voltage reference circuit.

In Aspect 3, the subject matter of Aspect 2 optionally includes the adjustable bandgap voltage reference circuit including a proportional-to-absolute-temperature (PTAT) circuit and a complementary-to-absolute-temperature (CTAT) circuit, and wherein at least one of the PTAT circuit and the CTAT circuit is adjustable.

In Aspect 4, the subject matter of Aspect 3, optionally includes the adjustable bandgap voltage reference circuit including an adjustable PTAT circuit.

In Aspect 5, the subject matter of Aspect 4 optionally includes the adjustable PTAT circuit including a PTAT current source and an adjustable resistor.

In Aspect 6, the subject matter of one or any combination of Aspects 3-5 optionally includes the adjustable bandgap voltage reference circuit including an adjustable CTAT circuit.

In Aspect 7, the subject matter of Aspect 6 optionally includes the adjustable CTAT circuit including a base-emitter voltage (VBE) multiplier circuit.

In Aspect 8, the subject matter of Aspect 6 optionally includes the adjustable CTAT circuit including multiple base-emitter voltage (VBE) multiplier circuit connected in series, wherein each VBE multiplier circuit increases a reference voltage of the voltage reference circuit.

In Aspect 9, the subject matter of Aspect 8 optionally includes each VBE multiplier circuit including an adjustable resistor.

In Aspect 10, the subject matter of one or any combination of Aspects 1-9 optionally includes a resistor-capacitor (RC) filter arranged between the bandgap voltage reference circuit and the first input of the amplifier circuit.

Aspect 11 includes subject matter (such as a method of generating a reference voltage in an integrated circuit) or can optionally be combined with one or any combination of Aspects 1-10 to include such subject matter, comprising connecting an adjustable complementary-to-absolute-temperature (CTAT) circuit and an adjustable proportional-to-absolute-temperature (PTAT) circuit in series to produce an adjustable reference output voltage at a first circuit node, connecting the first circuit node to a first input of an amplifier circuit, and connecting a second input of the amplifier circuit directly to an output of the amplifier circuit.

In Aspect 12, the subject matter of Aspect 11 optionally includes connecting an adjustable base-emitter voltage (VBE) multiplier circuit to the adjustable PTAT circuit.

In Aspect 13, the subject matter of one or both of Aspects 11 and 12 optionally includes connecting multiple adjustable base-emitter voltage (VBE) multiplier circuits to the adjustable PTAT circuit.

In Aspect 14, the subject matter of one or any combination of Aspects 11-13 optionally includes connecting a PTAT current source and an adjustable resistance to the adjustable CTAT circuit.

In Aspect 15, the subject matter of one or any combination of Aspects 11-14 optionally includes connecting a filter circuit to the first circuit node.

Aspect 16 includes subject matter (such as a voltage reference circuit) or can optionally be combined with one or any combination of Aspects 1-15 to include such subject matter, comprising a proportional-to-absolute-temperature (PTAT) circuit including multiple base-emitter voltage difference (ΔVBE) circuits, a complementary-to-absolute-temperature (CTAT) circuit, wherein outputs of the multiple ΔVBE circuits and the CTAT circuit are connected in series to produce an aggregate reference voltage at a first circuit node, and an amplifier circuit including a first input coupled to the first circuit node and a second input directly coupled to an output of the amplifier.

In Aspect 17, the subject matter of Aspect 16 optionally includes the CTAT circuit including a diode connected transistor.

In Aspect 18, the subject matter of one or both of Aspect 16 and Aspect 17 optionally includes the CTAT circuit including at least one base-emitter voltage (VBE) multiplier circuit.

In Aspect 19, the subject matter of one or any combination of Aspect 16-18 optionally includes the CTAT circuit including at least one adjustable VBE multiplier circuit.

In Aspect 20, the subject matter of one or any combination of Aspects 16-19 optionally includes a resistor-capacitor (RC) filter arranged between the voltage reference circuit and the first input of the amplifier circuit.

The non-limiting Aspects can be combined in any permutation or combination. Each of the non-limiting aspects described in this document can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

What is claimed is:

1. A voltage reference circuit, the circuit comprising:
a bandgap voltage reference circuit; and
an amplifier circuit including a first input coupled to an output of the bandgap voltage reference circuit and a second input directly coupled to an output of the amplifier.

2. The circuit of claim 1, wherein the bandgap voltage reference circuit is an adjustable bandgap voltage reference circuit.

3. The circuit of claim 2, wherein the adjustable bandgap voltage reference circuit includes a proportional-to-absolute-temperature (PTAT) circuit and a complementary-to-absolute-temperature (CTAT) circuit, and wherein at least one of the PTAT circuit and the CTAT circuit is adjustable.

4. The circuit of claim 3, wherein the adjustable bandgap voltage reference circuit includes an adjustable PTAT circuit.

5. The circuit of claim 4, wherein the adjustable PTAT circuit includes a PTAT current source and an adjustable resistor.

6. The circuit of claim 3, wherein the adjustable bandgap voltage reference circuit includes an adjustable CTAT circuit.

7. The circuit of claim 6, wherein the adjustable CTAT circuit includes a base-emitter voltage (VBE) multiplier circuit.

8. The circuit of claim 6, wherein the adjustable CTAT circuit includes multiple base-emitter voltage (VBE) multiplier circuit connected in series, wherein each VBE multiplier circuit increases a reference voltage of the voltage reference circuit.

9. The circuit of claim 8, wherein each VBE multiplier circuit includes an adjustable resistor.

10. The circuit of claim 1, including a resistor-capacitor (RC) filter arranged between the bandgap voltage reference circuit and the first input of the amplifier circuit.

11. A method of generating a reference voltage in an integrated circuit, the method comprising:
connecting an adjustable complementary-to-absolute-temperature (CTAT) circuit and an adjustable proportional-to-absolute-temperature (PTAT) circuit in series to produce an adjustable reference output voltage at a first circuit node;
connecting the first circuit node to a first input of an amplifier circuit; and
connecting a second input of the amplifier circuit directly to an output of the amplifier circuit.

12. The method of claim 11, wherein the connecting the adjustable CTAT circuit includes connecting an adjustable base-emitter voltage (VBE) multiplier circuit to the adjustable PTAT circuit.

13. The method of claim 11, wherein the connecting the adjustable CTAT circuit includes connecting multiple adjustable base-emitter voltage (VBE) multiplier circuits to the adjustable PTAT circuit.

14. The method of claim 11, wherein the connecting the adjustable PTAT circuit includes connecting a PTAT current source and an adjustable resistance to the adjustable CTAT circuit.

15. The method of claim 11, including connecting a filter circuit to the first circuit node.

16. A voltage reference circuit, the circuit comprising:
a proportional-to-absolute-temperature (PTAT) circuit including multiple base-emitter voltage difference (ΔVBE) circuits;
a complementary-to-absolute-temperature (CTAT) circuit, wherein outputs of the multiple ΔVBE circuits and the CTAT circuit are connected in series to produce an aggregate reference voltage at a first circuit node; and
an amplifier circuit including a first input coupled to the first circuit node and a second input directly coupled to an output of the amplifier.

17. The circuit of claim 16, wherein the CTAT circuit includes a diode connected transistor.

18. The circuit of claim 16, wherein the CTAT circuit includes at least one base-emitter voltage (VBE) multiplier circuit.

19. The circuit of claim 16, wherein the CTAT circuit includes an adjustable VBE multiplier circuit.

20. The circuit of claim 16, including a resistor-capacitor (RC) filter arranged between the voltage reference circuit and the first input of the amplifier circuit.
